(19) United States
(12) Patent Application Publication
(10) Pub. No.: US 2007/0029885 A1
(43) Pub. Date: Feb. 8, 2007

(54) Cooling system for vehicle alternator

(75) Inventor: Hiroshi Sakakibara, Chita-gun (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/488,070

(22) Filed: Jul. 18, 2006

(30) Foreign Application Priority Data
Aug. 4, 2005 (JP) 2005-226066

(51) Int. Cl. H02K 9/00

(52) U.S. Cl. 310/58; 310/52

(57) ABSTRACT

A front frame for an alternator mounted on a motor bicycle has a cooling air outlet window formed at an outer peripheral side of a stator coil wound on a stator and a cooling air inlet window formed at a front side of the alternator, namely, at an engine block side along an axis direction separated from a cooling fan. An outlet section of a cooling air duct is placed at a position near the cooling air inlet window. This configuration of the cooling system enhances its cooling capability of forcedly blowing the cooling air to the inside of the alternator, and prevents adhesion and accumulation of mud and sand to the cooling air inlet window, splashed to the cooling air inlet window while the motor bicycle is driving on a mud road.

### CROSS-REFERENCE TO RELATED APPLICATIONS

This application is related to and claims priority from Japanese Patent Application No. 2005-226066 filed on Aug. 4, 2005, the contents of which are hereby incorporated by reference.

### BACKGROUND OF THE INVENTION

1. Field of the invention

The present invention generally relates to a cooling system for a vehicle alternator to be mounted on a vehicle such as a motor bicycle.

2. Description of the Related Art

In general, a vehicle alternator (or referred to as “an alternator”, simply) mounted on a motor bicycle is exposed to the outer atmosphere. Such an alternator for a motor bicycle is directly engaged with an engine cover through a shaft, which is different in mechanism from an alternator mounted on a passenger car or a truck in which an alternator is engaged with an engine cover through a pulley and a belt. The Japanese patent laid open publication (No. JP H8-331786) has disclosed such a mechanism of the alternator mounted on a motor bicycle.

Because the alternator is directly mounted on the engine cover in a motor bicycle disclosed in the above patent document, the alternator exhausts a high temperature cooling air, and introduces air involving the exhausted cooling air through its inlet window or opening at a front side thereof. This cooling system of the alternator mounted on such a motor bicycle therefore reduces its cooling capability. In addition, the deterioration of the cooling capability of the cooling system reduces the lifetime of electric components and also mechanical components forming the alternator, and the output power of the alternator is thereby reduced by increasing the temperature of the stator and the rotor forming the alternator. Thus, there is the demand to improve such a cooling mechanism for the alternator mounted on a motor bicycle.

Further, because the alternator mounted on the motor bicycle is placed at the outside of the engine and exposed to the outer atmosphere, foreign matters such as muddy water and sand are splashed from the ground and then adhered to the cooling air inlet window formed at a front side of the alternator while the motor bicycle is running on a mud road. The accumulation of those foreign matters on the cooling air inlet window formed at the front side of the alternator reduces the amount of cooling air to be introduced to the alternator through the cooling window, and further decreases the cooling capability of the cooling system of the alternator. If those foreign matters such as muddy water and sand are accumulated on and adhered to the cooling air inlet window and then invade to the inside of the alternator, the invasion of the mud and sand to the inside of the alternator has a possibility to stop the operation of the alternator and to decrease the capability of the alternator to generate the electric power.

### SUMMARY OF THE INVENTION

It is an object of the present invention to provide a cooling system for a vehicle alternator having an improved cooling capability and capable of preventing accumulation of foreign matters such as muddy water and sand, splashed from a muddy road, on a cooling air inlet window of the alternator.

To achieve the above purposes, the present invention provides a cooling system for an alternator mounted on a vehicle, having a front frame, a rear frame, and a cooling air duct. The front frame is fixed to an engine fixture section side on which an engine is mounted. The front frame is configured to accommodate a rotor of the alternator having cooling fans, and to freely and rotationally support a rotary shaft of the alternator to be driven by the engine directly connected to the rotary shaft. The front frame has a cooling air outlet window and a cooling air inlet window. The cooling air outlet window is formed at an outer peripheral side of a stator coil that is wound on the stator. The stator is placed at an outer peripheral side of the rotor. The cooling air inlet window is formed at the engine fixture section side. The cooling air inlet window is separated from the cooling fans of the rotor along an axis direction of the rotary shaft. The rear frame is configured to accommodate a stator of the alternator. The cooling air duct has an inlet section and an outlet section. The inlet section is configured to introduce a cooling air. The outlet section configured to exhaust the cooling air is placed at the position near the cooling air inlet window of the front frame. Because the outlet section of the cooling air duct is placed at the position near the cooling air inlet window mounted on the front frame, it is thereby possible to introduce a fresh cooling air into the cooling air inlet window and to enhance the cooling capability for the alternator mounted on a vehicle such as a motor bicycle.

Further, according to another aspect of the present invention, the inlet section of the cooling air duct is placed in the running direction of the vehicle so that the cooling air is introduced into the inlet section of the cooling air duct in the running direction of the vehicle, and then exhausted from the outlet section of the cooling air duct in the backward direction to the running of the vehicle. It is thereby possible to efficiently introduce the cooling air into the cooling air duct and to blow the cooling air to the cooling air inlet window formed in the front frame. As a result, it is possible to blow the cooling air exhausted from the outlet section of the cooling air duct to foreign matters such as muddy water and sand splashed from the ground in the forward direction of running of the vehicle. Thus, it is thereby possible to eliminate any accumulation of muddy water and sand on the cooling air inlet window formed in the front frame.

Still further, according to another aspect of the present invention, the rotary shaft of the rotor is assembled to the vehicle in parallel to the ground, and the outlet section of the cooling air duct is placed at the position under the rotary shaft of the rotor. Because muddy water and sand splashed from the ground during the running of the vehicle are adhered mainly to the front frame under the position of the rotary shaft, it is possible to efficiently eliminate those muddy water and sand splashed from the ground by the cooling air forcedly exhausted from the outlet section of the cooling air duct placed at the position near the cooling air inlet window under the position of the rotary shaft.

Still further, according to another aspect of the present invention, the cooling air duct is so placed that the cooling air exhausted from the outlet section of the cooling air duct do not interfere with the cooling air exhausted from the cooling air outlet window. It is thereby possible to further enhance the cooling capability of the cooling system and to prevent decreasing of the flow speed of the cooling air and decreasing of the flow amount of the cooling air even if the cooling air duct is added to the cooling system.

Furthermore, according to another aspect of the present invention, a sectional area of the inlet section of the cooling air duct is greater than a sectional area of the outlet section of the cooling air duct. Because the blowing speed of the cooling air exhausted from the outlet section of the cooling air duct is thereby accelerated, it is possible to efficiently eliminate muddy water and sand splashed from the ground and also to prevent the accumulation of those foreign matters on the cooling air inlet window and the cooling air outlet window formed in the front frame.

### BRIEF DESCRIPTION OF THE DRAWINGS

A preferred, non-limiting embodiment of the present invention will be described by way of example with reference to the accompanying drawings, in which:

FIG. 1 is a sectional view showing an entire configuration of an alternator equipped with a cooling system to be mounted on a vehicle such as a motor bicycle according to a first embodiment of the present invention;

FIG. 2 is a plan view of the alternator equipped with the cooling system shown in FIG. 1;

FIG. 3 is a rear view of the alternator equipped with the cooling system shown in FIG. 1;

FIG. 4 is a schematic side view showing a motor bicycle on which the alternator equipped with the cooling system of the embodiment is mounted;

FIG. 5 is a detailed side view showing the alternator equipped with the cooling system of the embodiment;

FIG. 6 is a detailed rear view showing the alternator equipped with the cooling system of the embodiment; and

FIG. 7 is a detailed rear view showing the alternator equipped with the cooling system according to a modified example of the embodiment.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Embodiment

A description will be given of the configuration of the cooling system for a vehicle alternator according to the first embodiment of the present invention with reference to diagrams.

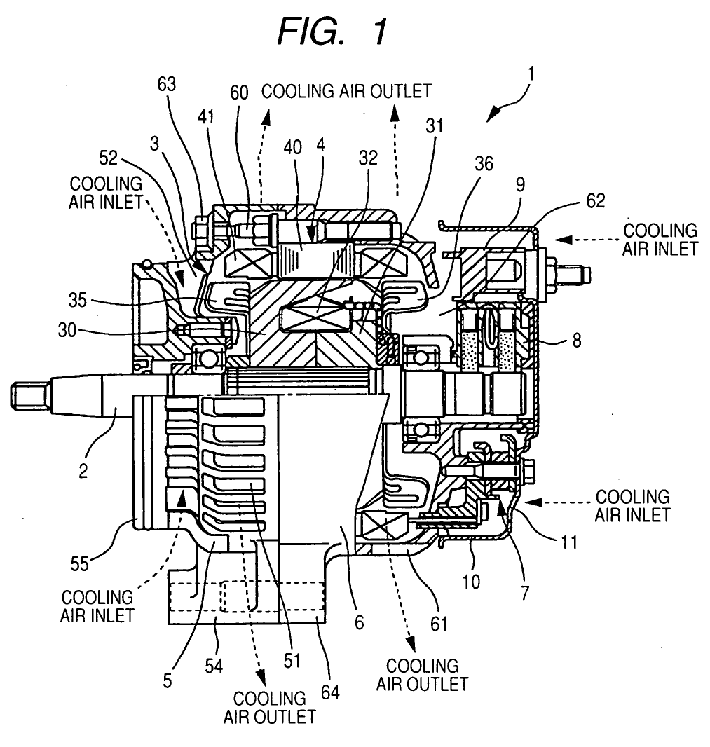

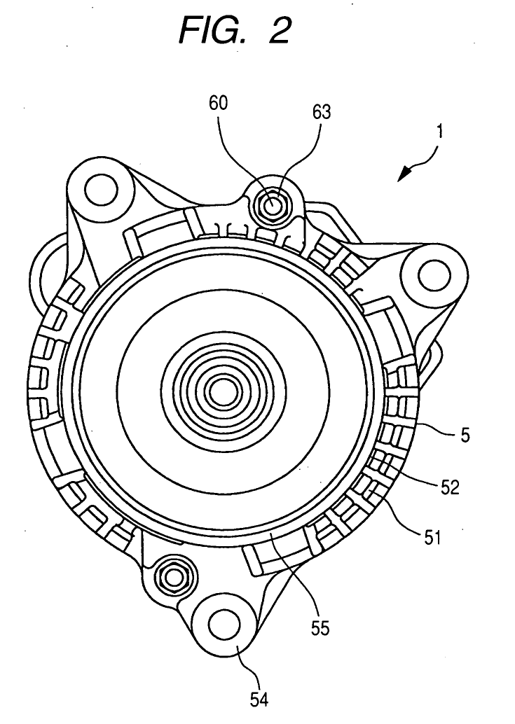

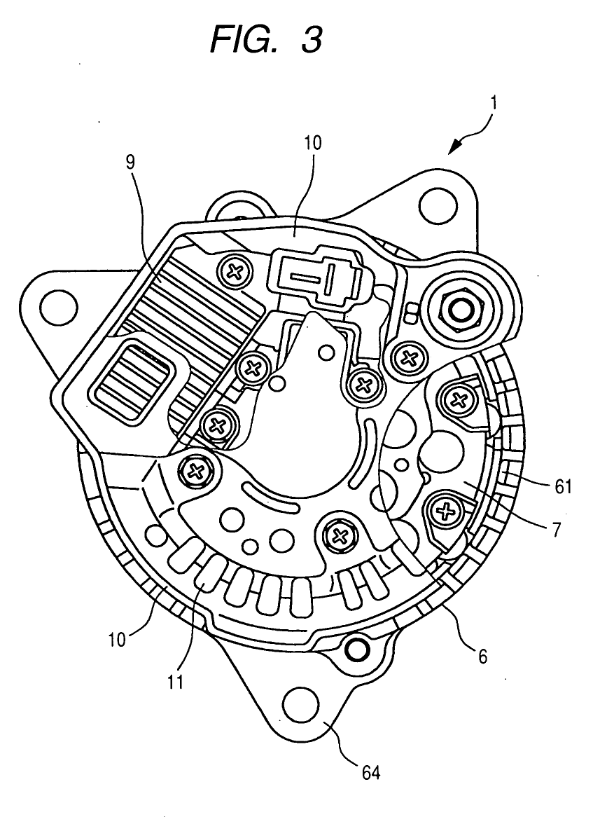

FIG. 1 is a sectional view showing an entire configuration of the vehicle alternator equipped with the cooling system to be mounted on a motor bicycle as a vehicle according to the first embodiment of the present invention. FIG. 2 is a plan view of the alternator equipped with the cooling system and FIG. 3 is a rear view of the alternator equipped with the cooling system.

As shown in FIG. 1, the vehicle alternator 1 (or referred to as “an alternator”, simply) has a rotary shaft 2, a rotor 3, a stator 4, a front frame 5, a rear frame 6, a rectifier unit 7, a brush unit 8, a regulator 9 as a voltage control unit, and the like. A front part of the rotary shaft 2 is engaged with a gear 102 as an engine side driving component placed in the engine block 100 in order to receive the output power of an internal combustion engine (or referred to as “an engine”, simply). The alternator thereby rotates by the received output power transmitted from the engine through the rotary shaft 2.

The rotor 3 acts as a field magnet and rotates together with the rotary shaft 2. The rotor 3 has a pair of Randel-type pole cores 30 and 31, a field coil 32, and cooling fans 35 and 36. Each of Randel-type pole cores 30 and 31 is made of a boss section pressed in the rotary shaft 2, a disk section extending in a radial direction from a part near an end part of the boss section, and a plurality of claw poles (for example, six claw poles) extending from an outer peripheral part of the disk section in the axis direction. The cooling fan 35 is fixed to the end surface of the pole core 30, placed at the engine block 100 side, in the axis direction by soldering manner. The cooling fan 35 is a mixed flow fan capable of guiding inlet cooling air along the direction of centrifugal force or the axis direction. The cooling air guided along the axis direction flows between the claw poles adjacent to each other in the pole cores 30 and 31 or between the claw poles and the stator 4 in order to cool the rotor 3 and the stator 4. The cooling fan 36 is fixed to the end surface of the pole core 31 on the opposite side of the engine block 100, in the axis direction. For example, the cooling fan 36 is a centrifugal-force fan having blades vertical to the end surface of the pole core 31 in the axis direction, and guides the inlet cooling air toward a centrifugal-force direction. Dotted lines shown in FIG. 1 designate the flow of inlet and outlet cooling air at the front frame 5 and the flow of inlet and outlet cooling air at the rear frame 6.

The stator 4 has a stator core 40 and a stator coil 41. Plural slots are formed in the stator core 40. The stator coil 41 is wound on each of the slots and a part of the stator coil 41 is exposed to the atmosphere from the end surface of the stator core 40 in the axis direction.

The front frame 5 is assembled to the engine block 100 side in which the engine is placed. The front frame 5 has plural cooling air outlet windows 51 and cooling air inlet windows 52. The cooling air outlet windows 51 are formed at the outer peripheral area of the coil end of the stator coil 41. The cooling air inlet windows 52 are formed at the engine block 100 side along the axis direction separated from the cooling fan 35.

The rear frame 6 is assembled to the area on the opposite side of the engine block 100, and accommodates and supports the stator 4. The stator 4 is fixed to the rear frame 6 by a part of the end surface of the stator core 40 in the axis direction to which engaging force is supplied in the axis direction by plural stud bolts 60.

The electric components such as the rectifier unit 7, the brush unit 8, and the regulator 9 are placed at the outside of the rear frame 6 in the axis direction. The rear cover 10 accommodates the rear frame 6. Further, the rear frame 6 has the plural cooling air outlet windows 61 and the cooling air inlet windows 62. The plural cooling air outlet windows 61 are formed at the outer peripheral area of the coil end of the stator coil 41. The plural cooling air inlet windows 62 are formed at the rear side (on the opposite side of the engine block 100) of the rear frame 6 along the axis direction separated from the cooling fan 36.

Further, the cooling air inlet windows 11 are formed at the end surface of the rear cover 10 in the axis direction. While the cooling fan 36 rotates together with the rotor 3, the cooling air is introduced through the cooling air inlet window 11 formed in the rear cover 10 and then cools the electric components. After this, the cooling air is introduced near the cooling fan 36 through the cooling air inlet window 62 formed in the rear frame 6. After cooling the rear side coil end of the stator coil 41, the cooling air is exhausted to the outside through the cooling air outlet window 61.

The front frame 5 is fastened to the rear frame 6 by stud bolts capable of fixing the stator 4. Plural stay sections 54 having fixture through-holes are formed at the outer diameter side of the front frame 5. Further, plural stay sections 64 having fixture through-holes are formed at the outer diameter side of the rear frame 6. Bolts 12 are inserted from the rear frame side while aligning the fixture through-holes formed in both the stay sections 54 and 64 to each other, and then fastened. Thereby, the front frame 5 and the rear frame 6, namely, the entire of the alternator 1 is fixed to the engine block 100. In this condition, the front end of the rotor 2 is engaged with the gear 102 placed in the engine block 100, and the rotation force of the engine is transmitted to the alternator 1 through the rotary axis 2.

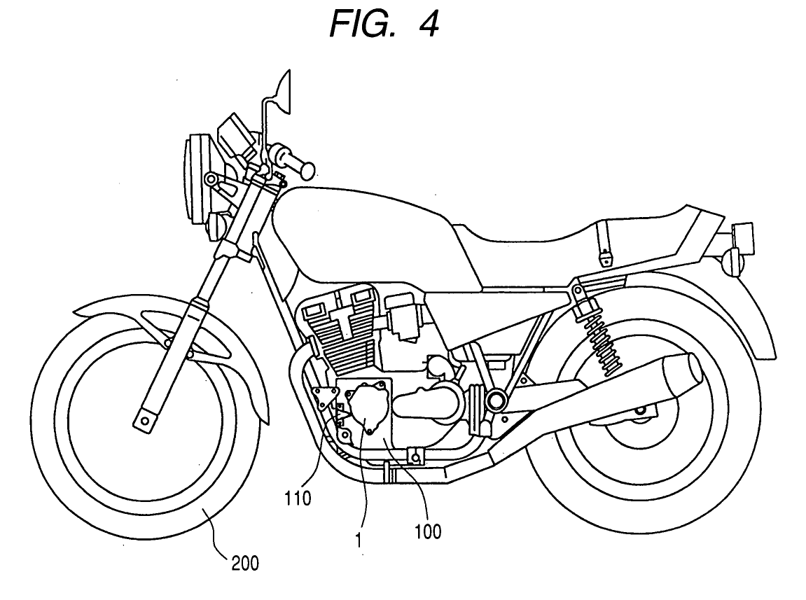

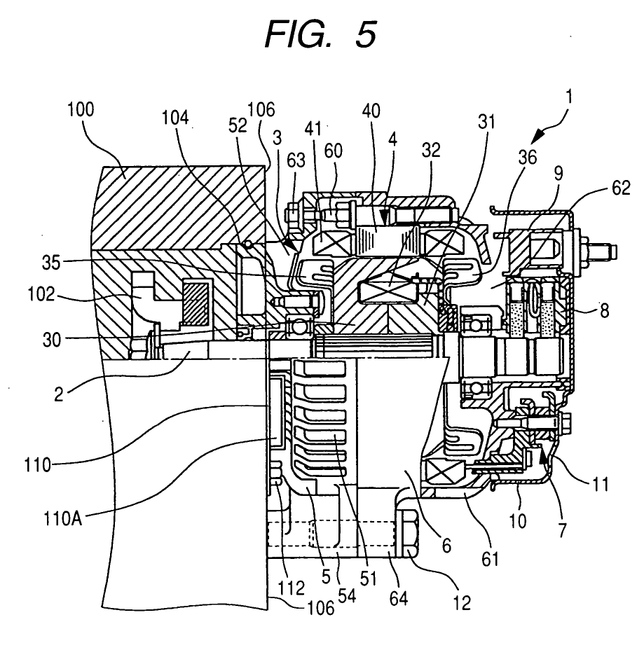

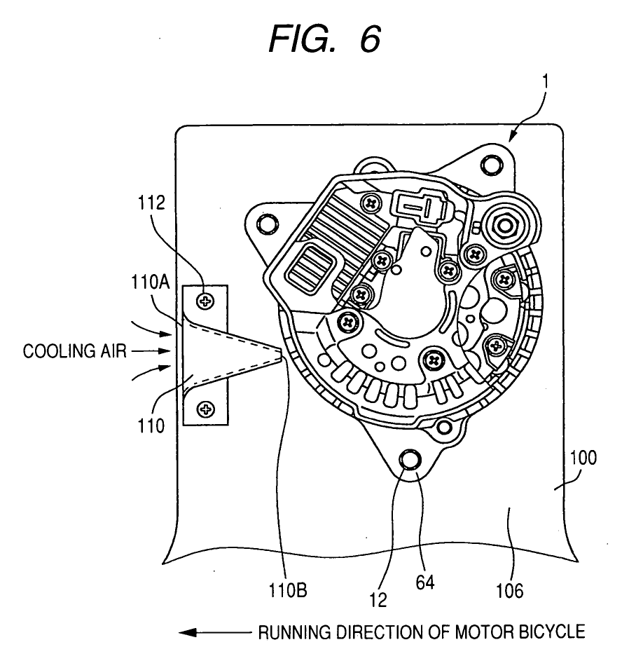

FIG. 4 is a schematic side view showing a motor bicycle on which the alternator 1 equipped with the cooling system of the embodiment is mounted. FIG. 5 is a detailed side view showing the alternator 1 equipped with the cooling system of the embodiment. FIG. 6 is a detailed rear view showing the alternator 1 equipped with the cooling system of the embodiment.

As shown in FIG. 4 to FIG. 6, the engine block 100 has a concave section 104 and the fixture surface 106. The concave section 104 corresponds to a flange section 55 of a cylindrical shape formed at the front end surface of the front frame 5. The fixture surface 106 (at the engine side) has a larger dimension in the radial direction than the outer diameter of the cooling air outlet window 51 formed at the front frame 5.

As shown in FIG. 6, a cooling air duct 110 is mounted on the fixture surface 106 of the engine block 100. The cooling air duct 110 forcedly introduces, guides a fresh cooling air, and exhausts the accelerated cooling air. The accelerated cooling air is supplied into the inside of the alternator 1 through the cooling air inlet window 52 while a motor bicycle equipped with the alternator 1 is running.

Further, the cooling air duct 110 is capable of blowing the accelerated cooling air to foreign matters such as muddy water and sand splashed from the front tire 200 of the motor bicycle (shown in FIG. 4), in order to blow off the cooling air to those foreign matters in the area under the rotary shaft 2 (at the ground side) near the cooling air inlet window 52.

As shown in both FIG. 5 and FIG. 6, the cooling air duct 110 has a configuration in which the sectional area of the outlet section 110B is smaller than the sectional area of the inlet section 110A. The cooling air duct 110 is mounted on the fixture surface 106 of the engine block 100. It is so placed that the mount position of the cooling air duct 110 do not interfere the cooling air exhausted from the cooling air outlet window 51 formed in the front frame 5. The cooling air duct 110 is placed below the rotary shaft 2 of the alternator 1 that is placed approximately in parallel to the ground. The cooling air duct 110 is fixed to the fixture surface 106 of the engine block 100 by screws 112.

As shown in FIG. 6, because the inlet section 110A of the cooling air duct 110 is placed at the front side of the engine block 100 in the running direction of the motor bicycle, the cooling air introduced through the inlet section 110A is thereby accelerated in the cooling air duct 110, and then exhausted through the outlet section 110B to the rearward of the running direction of the motor bicycle. That is, the cooling air duct 110 forcedly blows off the accelerated cooling air to the lower area of the cooling air inlet window 52 of the front frame 5 and the forward section in the running direction of the motor bicycle.

As described above, the outlet section 110B of the cooling air duct 110 is placed near the cooling air inlet window 52 as the cooling system of the alternator 1 for a vehicle according to the embodiment of the present invention, it is possible to supply the accelerated freshly cooling air to the cooling air inlet window 52, and thereby to enhance the cooling capability for the alternator 1.

In addition, because the cooling air duct 110 is open at the front section in the running direction of the motor bicycle and can forcedly exhaust the accelerated cooling air from the outlet section 110B toward the opposite direction of the running direction of the motor bicycle. This mechanism can supply the cooling air efficiently into the cooling air duct 110, and forcedly blows the cooling air to the cooling air inlet window 52 formed in the front frame 5, and it is possible to eliminate foreign matters such as muddy water and sand splashed from the ground at the front section of the motor bicycle while the motor bicycle as a vehicle is running. This cooling system can prevent the accumulation of foreign matters on the area including the cooling air inlet window 52.

Further, because muddy water and sand are splashed mainly on the front and under the rotary shaft 2 of the alternator 1 while the motor bicycle is traveling, namely, splashed toward the front area of the alternator faced to the ground side in the motor bicycle, it is possible to eliminate efficiency such foreign matters splashed from the ground, while the motor bicycle is running, by placing the outlet section 110B of the cooling air duct 110 at the under side of the rotary shaft 2.

Still further, because the cooling air duct 110 is placed and separated adequately from the cooling air outlet window 51 so that it does not interfere in the cooling air discharged from the cooling air outlet window 51, it is possible to further enhance the cooling capability while preventing the decrease of amount of cooling air and the speed of cooling air.

Moreover, because the cooling air duct 110 has the outlet section 110B whose area is smaller than that of the inlet section 110A, it is possible to accelerate the speed of the cooling air and to increase the amount of the cooling air exhausted from the outlet section 110B of the cooling air duct 110, and it is thereby possible to efficiently eliminate muddy water and sand splashed from the ground toward the front area of the motor bicycle.

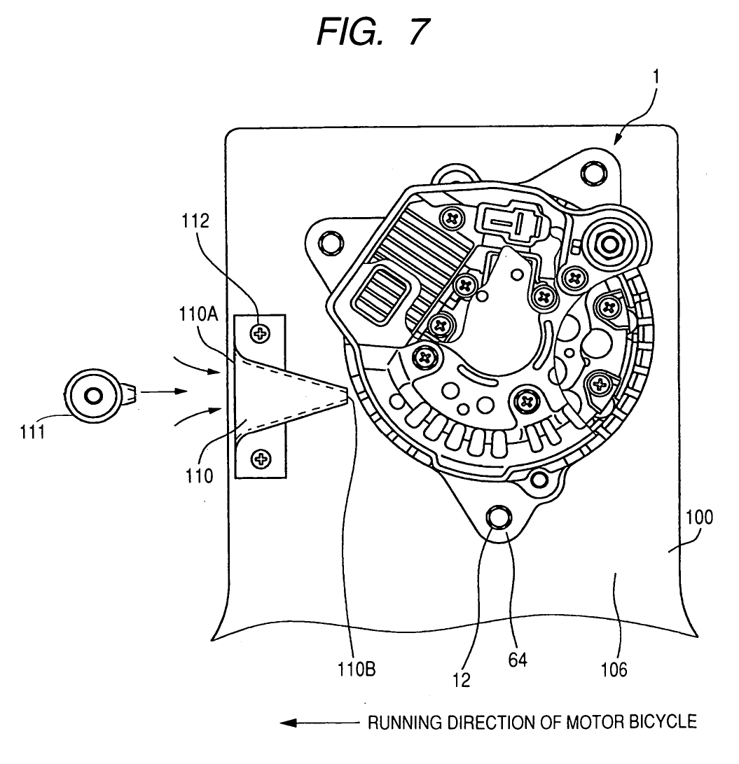

The present invention is not limited by the above embodiment and can be applied to other modifications. For example, as shown in FIG. 7, it is acceptable to forcedly supply the cooling air into the cooling air duct 110 by placing an air blow fan 111 at the front area of the inlet section 110A of the cooling air duct 110, instead of the configuration of the above embodiment.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A cooling system for an alternator mounted on a vehicle, comprising:
a front frame fixed to an engine fixture section side to which an engine is assembled, configured to accommodate a rotor of the alternator having cooling fans, and to freely and rotationally support a rotary shaft of the alternator to be driven by the engine directly connected to the rotary shaft, and
the front frame comprising:
a cooling air outlet window formed at an outer peripheral side of a stator coil wound on the stator placed at an outer peripheral side of the rotor; and
a cooling air inlet window formed at the engine fixture section side and separated from the cooling fans of the rotor along an axis direction of the rotary shaft;
a rear frame configured to accommodate a stator of the alternator; and
a cooling air duct having an inlet section configured to introduce a cooling air, and an outlet section configured to exhaust the cooling air placed at a position near the cooling air inlet window of the front frame.

2. The cooling system for a vehicle alternator mounted on a vehicle according to claim 1, wherein the inlet section of the cooling air duct is placed in a running direction of the vehicle so that the cooling air is introduced into the inlet section of the cooling air duct in the running direction of the vehicle, and exhausted through the outlet section of the cooling air duct backward of the running direction of the vehicle.

3. The cooling system for a vehicle alternator mounted on a vehicle according to claim 1, wherein the rotary shaft of the rotor is assembled in the vehicle in parallel to a ground, and
the outlet section of the cooling air duct is placed at a position under the rotary shaft of the rotor.

4. The cooling system for a vehicle alternator mounted on a vehicle according to claim 2, wherein the rotary shaft of the rotor is assembled to the vehicle in parallel to a ground, and
the outlet section of the cooling air duct is placed at a position under the rotary shaft of the rotor.

5. The cooling system for a vehicle alternator mounted on a vehicle according to claim 1, wherein the cooling air duct is so placed that the cooling air exhausted from the outlet section of the cooling air duct do not interfere with the cooling air exhausted from the cooling air outlet window.

6. The cooling system for a vehicle alternator mounted on a vehicle according to claim 2, wherein the cooling air duct is so placed that the cooling air exhausted from the outlet section of the cooling air duct do not interfere with the cooling air exhausted from the cooling air outlet window.

7. The cooling system for a vehicle alternator mounted on a vehicle according to claim 3, wherein the cooling air duct is so placed that the cooling air exhausted from the outlet section of the cooling air duct do not interfere with the cooling air exhausted from the cooling air outlet window.

8. The cooling system for a vehicle alternator mounted on a vehicle according to claim 1, wherein a sectional area of the inlet section of the cooling air duct is larger than a sectional area of the outlet section of the cooling air duct.

9. The cooling system for a vehicle alternator mounted on a vehicle according to claim 2, wherein a sectional area of the inlet section of the cooling air duct is larger than a sectional area of the outlet section of the cooling air duct.

10. The cooling system for a vehicle alternator mounted on a vehicle according to claim 3, wherein a sectional area of the inlet section of the cooling air duct is larger than a sectional area of the outlet section of the cooling air duct.

11. The cooling system for a vehicle alternator mounted on a vehicle according to claim 5, wherein a sectional area of the inlet section of the cooling air duct is larger than a sectional area of the outlet section of the cooling air duct.

12. The cooling system for a vehicle alternator mounted on a vehicle according to claim 1, further comprising an air blow fan configured to forcedly supply cooling air into the inlet section of the cooling air duct.
